(19) United States
(12) Patent Application Publication
(10) Pub. No.: US 2014/0286212 A1
(43) Pub. Date: Sep. 25, 2014

(54) INFORMATION PROCESSING SYSTEM, INFORMATION PROCESSING APPARATUS, AND COMPUTER-READABLE MEDIUM

(71) Applicant: FUJI XEROX CO., LTD., Tokyo (JP)

(72) Inventor: Takanari ISHIMURA, Kanagawa (JP)

(21) Appl. No.: 13/941,786

(22) Filed: Jul. 15, 2013

(30) Foreign Application Priority Data
Mar. 25, 2013 (JP) 2013-062808

(51) Int. Cl. H04W 52/02

(52) U.S. Cl. CPC H04W 52/0206
USPC 370/311

(57) ABSTRACT

An information processing system includes a first wireless communication apparatus, a second wireless communication apparatus, and an information processing apparatus. The first wireless communication apparatus receives data from a mobile communication terminal, and is capable of switching between an active state and a non-active state. The second wireless communication apparatus receives first identification information from the mobile communication terminal. In the second wireless communication apparatus, a first communication-capable range produced when the first wireless communication apparatus is in the active state overlaps or matches a second communication-capable range of the second wireless communication apparatus. The information processing apparatus generates a switching instruction to switch the first wireless communication apparatus from the non-active state to the active state when the second wireless communication apparatus receives the first identification information.

### CROSS-REFERENCE TO RELATED APPLICATIONS

This application is based on and claims priority under 35 USC 119 from Japanese Patent Application No. 2013-062808 filed Mar. 25, 2013.

### BACKGROUND

### Technical Field

The present invention relates to an information processing system, an information processing apparatus, and a computer-readable medium.

### SUMMARY

According to an aspect of the present invention, there is provided an information processing system including a first wireless communication apparatus, a second wireless communication apparatus, and an information processing apparatus. The first wireless communication apparatus receives data from a mobile communication terminal, and is capable of switching between an active state and a non-active state. The second wireless communication apparatus receives first identification information from the mobile communication terminal. In the second wireless communication apparatus, a first communication-capable range produced when the first wireless communication apparatus is in the active state overlaps or matches a second communication-capable range of the second wireless communication apparatus. The information processing apparatus generates a switching instruction to switch the first wireless communication apparatus from the non-active state to the active state when the second wireless communication apparatus receives the first identification information.

### BRIEF DESCRIPTION OF THE DRAWINGS

Exemplary embodiment of the present invention will be described in detail based on the following figures, wherein:

FIG. 1 is a diagram illustrating an exemplary configuration of an information processing system;

FIG. 2 is a diagram illustrating an exemplary configuration of an information processing apparatus;

FIG. 3 is a diagram illustrating an exemplary filter included in an access point;

FIG. 4 is a diagram illustrating an exemplary operation of a mobile communication terminal;

FIG. 5 is a diagram illustrating a first exemplary operation of the information processing apparatus; and

FIG. 6 is a diagram illustrating a second exemplary operation of the information processing apparatus.

### DETAILED DESCRIPTION

An exemplary embodiment for an information processing system, an information processing apparatus, and a program in the present invention will be described referring to the drawings.

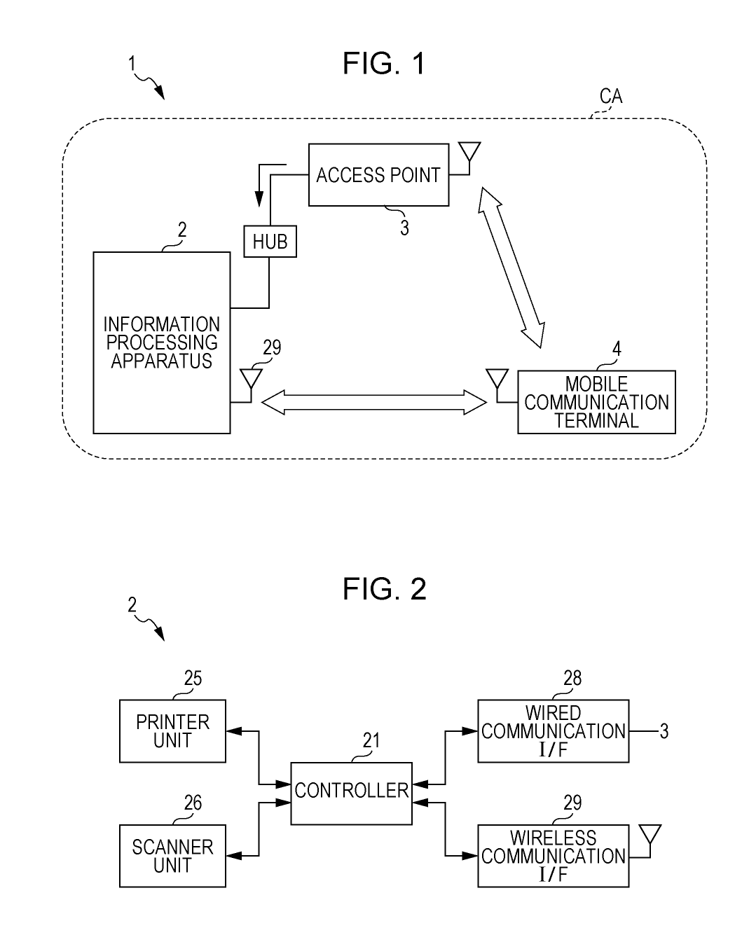

FIG. 1 is a diagram illustrating an exemplary configuration of an information processing system 1. The information processing system 1 includes an information processing apparatus 2 and at least one access point 3. The information processing apparatus 2 and an access point 3 are connected to a wired communication network so as to be capable of communicating with each other.

The information processing apparatus 2 is equipment having, for example, a printer function and a scanner function. The information processing apparatus 2 includes a wireless communication interface (I/F) 29 which is an exemplary first wireless communication apparatus, and is capable of direct wireless communication with a mobile communication terminal 4. That is, the information processing apparatus 2 and the mobile communication terminal 4 are capable of direct wireless communication with each other without the access point 3 through one-to-one connection. This direct wireless communication is achieved through, for example, the Wi-Fi Direct function. The information processing apparatus 2, for example, prints image data received from the mobile communication terminal 4, and transmits image data obtained through scanning to the mobile communication terminal 4.

The wireless communication I/F 29 of the information processing apparatus 2 is capable of switching between the active state and the non-active state. The active state indicates a state in which, for example, the amount of electrical power supplied to the wireless communication I/F 29 is large enough to enable the wireless communication. In FIG. 1, a communication-capable range CA produced when the wireless communication I/F 29 is in the active state is represented by a dashed line. The non-active state indicates a state in which, for example, the amount of electrical power supplied to the wireless communication I/F 29 is exactly or approximately zero. Thus, a communication-capable range produced when the wireless communication I/F 29 is in the non-active state is, for example, equal to zero.

The access point 3 is an exemplary second wireless communication apparatus, and is capable of wireless communication with the mobile communication terminal 4. Specifically, a connection to a wired communication network via the access point 3 (so-called an infrastructure connection) is provided for the mobile communication terminal 4. The access point 3 stores in advance identification information such as the MAC address of the mobile communication terminal 4 for which an infrastructure connection is provided. The access point 3 receives the identification information from the mobile communication terminal 4. In the case where the received identification information is stored in advance, the access point 3 provides an infrastructure connection for the mobile communication terminal 4. In contrast, in the case where the received identification information is not stored in advance, the access point 3 does not provide an infrastructure connection for the mobile communication terminal 4. That is, transfer of data other than the identification information is restricted.

In the exemplary embodiment, the access point 3 transmits, for example, the identification information of the mobile communication terminal 4 to the information processing apparatus 2. This operation will be described below.

The communication-capable range of the access point 3 overlaps or matches the communication-capable range CA produced when the wireless communication I/F 29 is in the active state. FIG. 1 illustrates an example in which the communication-capable range of the access point 3 matches the communication-capable range CA produced when the wireless communication I/F 29 is in the active state, but the present invention is not limited to this. For example, the entire communication-capable range for the access points 3 may overlap the communication-capable range CA produced when the wireless communication I/F 29 is in the active state.

The mobile communication terminal 4 is a portable terminal having a wireless communication function, and is, for example, a cellular phone (including a smart phone), a tablet computer, or a laptop computer.

FIG. 2 is a diagram illustrating an exemplary configuration of the information processing apparatus 2. The information processing apparatus 2 includes a controller 21, a printer unit 25, a scanner unit 26, a wired communication I/F 28, and the wireless communication I/F 29.

The controller 21 includes, for example, an arithmetic logical unit such as a central processing unit (CPU) and a storage unit such as a random access memory (RAM), and performs information processing in accordance with programs. The programs may be provided from a computer-readable information recording medium such as a compact disc-read-only memory (CD-ROM), or may be provided via a communication line such as the Internet.

The printer unit 25 is a unit for achieving a function as a printer, and forms an image on the surface of a medium in accordance with instructions from the controller 21. The scanner unit 26 is a unit for achieving a function as a scanner, and outputs image data which is read out from the surface of a medium to the controller 21.

The wired communication I/F 28 is equipment for performing wired communication with other apparatuses (e.g., the access point 3) through a wired communication network. The wireless communication I/F 29 is equipment for performing direct wireless communication with the mobile communication terminal 4 as described above, and is equipment for achieving, for example, the Wi-Fi Direct function.

The user of a mobile communication terminal 4 whose identification information is registered in advance in the access point 3 (hereinafter, referred to as a regular user) is allowed to use the information processing apparatus 2 via the access point 3. In contrast, the user of a mobile communication terminal 4 whose identification information is not registered in advance in the access point 3 (hereinafter, referred to as a temporary user) is not allowed to use the information processing apparatus 2 via the access point 3. Thus, a temporary user uses the information processing apparatus 2 through the Wi-Fi Direct function with which the information processing apparatus 2 and the mobile communication terminal 4 communicate with each other through direct wireless communication.

An information processing apparatus of the related art is provided with a mechanical button for starting the Wi-Fi Direct function. When a temporary user is to use the information processing apparatus, it is necessary for the user to go to the information processing apparatus and press the button, which is a troublesome startup operation. In addition, when the Wi-Fi Direct function is constantly on, the power consumption may be excessively high.

Therefore, when the information processing apparatus 2 according to the exemplary embodiment detects the mobile communication terminal 4 of a temporary user which is present in the communication-capable range CA, via the access point 3, the information processing apparatus 2 switches the wireless communication I/F 29 from the non-active state to the active state, whereby the operation of starting the Wi-Fi Direct function is simplified and the power consumption is reduced. The operations of the information processing apparatus 2, the access point 3, and the mobile communication terminal 4 will be specifically described below.

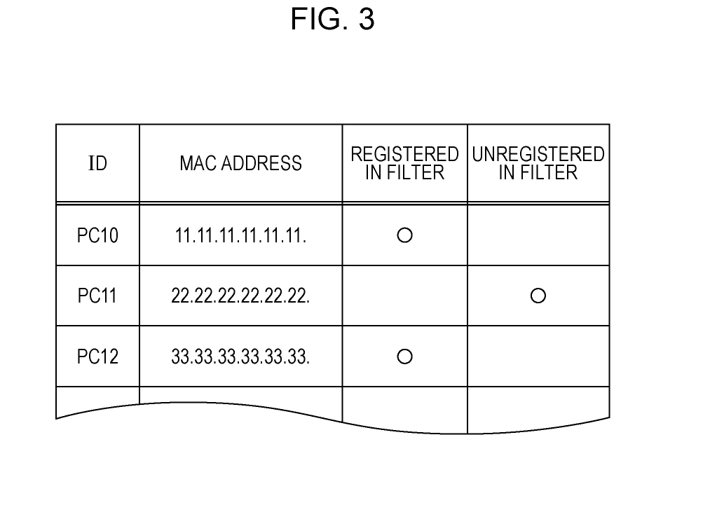

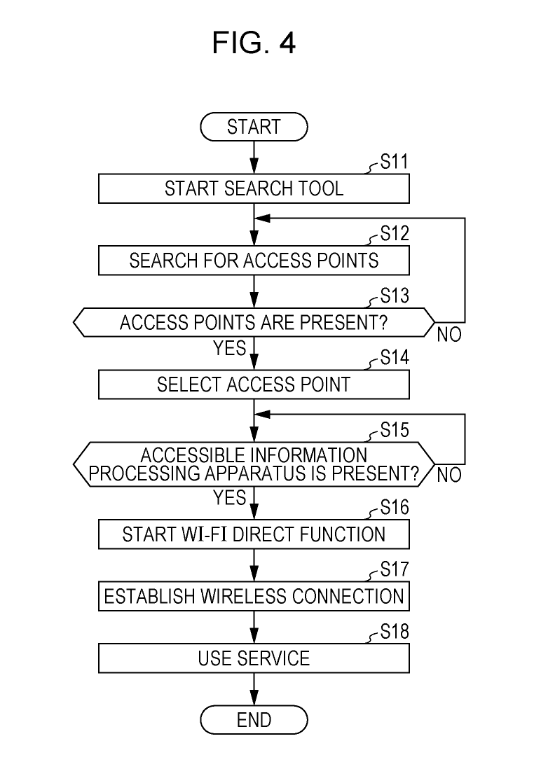

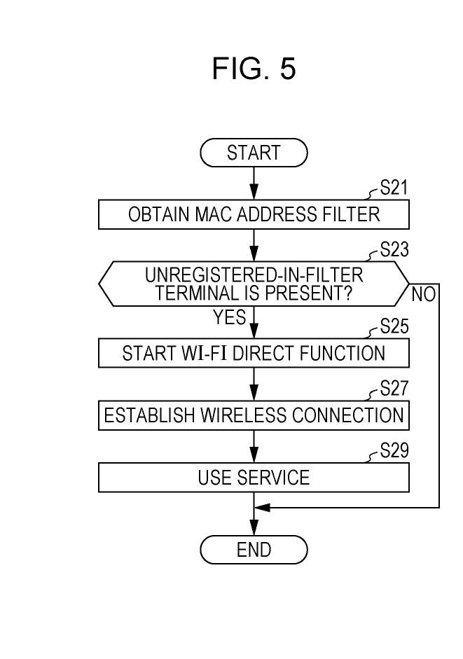

FIG. 3 is a diagram illustrating an exemplary filter included in the access point 3. FIG. 4 is a diagram illustrating an exemplary operation of the mobile communication terminal 4. FIG. 5 is a diagram illustrating a first exemplary operation of the information processing apparatus 2.

In the mobile communication terminal 4 of a temporary user, a search tool is started in step S11 in FIG. 4. The search tool is started when, for example, the temporary user is to use the information processing apparatus 2. The search tool searches for access points 3 which are present around the mobile communication terminal 4 in steps S12 and S13. The search for access points 3 is performed, for example, on the basis of the intensities of the radio waves which are transmitted from the access points 3 and which are received by the mobile communication terminal 4. The identification information such as service set identifiers (SSIDs) of the access points 3 extracted by the search tool is listed on the screen of the mobile communication terminal 4.

When the temporary user selects an access point 3 in step S14, the mobile communication terminal 4 transmits its MAC address to the selected access point 3. When the access point 3 receives the MAC address of the mobile communication terminal 4 of the temporary user, the access point 3 determines that the MAC address is not registered in advance, and stores it as a MAC address which has not been registered, in a MAC address filter (see FIG. 3). Therefore, for the mobile communication terminal 4 of the temporary user, infrastructure connection is not provided, and transfer of data other than registration of a MAC address is restricted.

The information processing apparatus 2 obtains the MAC address filter from the access point 3 in step S21 in FIG. 5 (i.e., a function as an exemplary acquisition unit). The acquisition of a MAC address filter is achieved, for example, by using a management information base (MIB) in the Simple Network Management Protocol (SNMP) 802.11. The information processing apparatus 2 determines whether or not an unregistered-in-filter terminal is present in the obtained MAC address filter in step S23. Thus, the information processing apparatus 2 recognizes that the mobile communication terminal 4 of the temporary user is present in the communication-capable range CA. Then, the information processing apparatus 2 starts the Wi-Fi Direct function in step S25. That is, the controller 21 of the information processing apparatus 2 generates an instruction to switch the wireless communication I/F 29 from the non-active state to the active state, and outputs the instruction to the wireless communication I/F 29 (i.e., a function as an exemplary generation unit). When the Wi-Fi Direct function is started, the wireless communication I/F 29 transmits a Wi-Fi protected setup (WPS) packet.

When the mobile communication terminal 4 of the temporary user receives the WPS packet, the mobile communication terminal 4 determines that an accessible information processing apparatus 2 is present nearby (YES in step S15 in FIG. 4), and displays a message indicating this on the screen. Thus, the temporary user recognizes that an accessible information processing apparatus 2 is present nearby. When the temporary user selects the information processing apparatus 2 on the screen of the mobile communication terminal 4 to use the information processing apparatus 2, the WPS of the Wi-Fi Direct function is performed in step S16. As a result, the wireless connection is established, and the Internet Protocol (IP) communication is available in step S17 in FIG. 4 and in step S27 in FIG. 5. Thus, the mobile communication terminal 4 of the temporary user is allowed to use the service, such as printing and scanning, provided by the information processing apparatus 2, through operations performed on the mobile communication terminal 4, in step S18 and step S29.

In the exemplary embodiment described above, the information processing apparatus 2 regularly obtains a MAC address filter from an access point 3, and thereby detects the mobile communication terminal 4 of a temporary user. However, the present invention is not limited to this. For example, when the access point 3 detects the mobile communication terminal 4 of a temporary user, the access point 3 may instruct the information processing apparatus 2 to start the Wi-Fi Direct function.

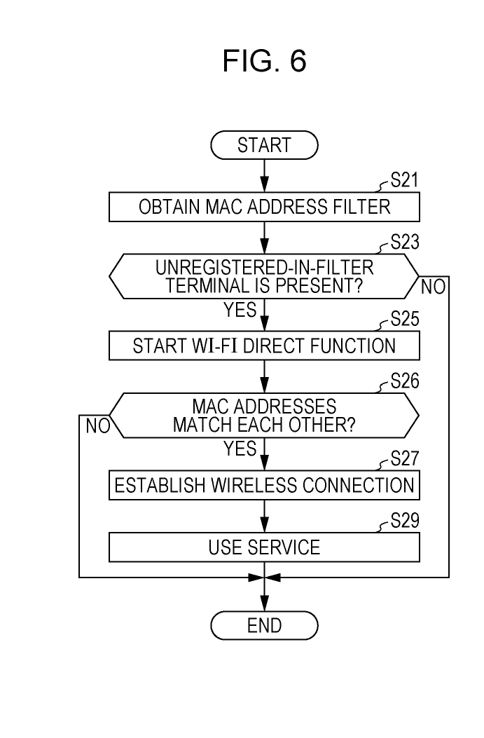

In addition, the information processing apparatus 2 may use the obtained MAC address to authenticate the mobile communication terminal 4 of a temporary user. FIG. 6 is a diagram illustrating a second exemplary operation of the information processing apparatus 2. Steps similar to those in the first exemplary operation described above are designated with identical numbers, and will not be described in detail. In the second exemplary operation, after starting the Wi-Fi Direct function in step S25, the information processing apparatus 2 directly obtains the MAC address from the mobile communication terminal 4 of a temporary user, compares the obtained MAC address with the MAC address of the mobile communication terminal 4 of the temporary user which is obtained from the access point 3, and determines whether or not these MAC addresses match each other in step S26 (i.e., a function as a comparison unit). If the MAC addresses match each other (YES in step S26), the wireless connection is established and the IP communication is available in step S27.

Further, the information processing apparatus 2 may start the Wi-Fi Direct function when the access point 3 receives intention information indicating an intention to use the information processing apparatus 2, along with the identification information from the mobile communication terminal 4. For example, startup of the search tool in the mobile communication terminal 4 (step S11 in FIG. 4) indicates that the temporary user intends to use the information processing apparatus 2. Therefore, information indicating startup of the search tool may be transmitted as intention information from the mobile communication terminal 4 to the access point 3.

In the exemplary embodiment described above, when the information processing apparatus 2 detects the mobile communication terminal 4 of a temporary user, the information processing apparatus 2 starts the Wi-Fi Direct function. However, the present invention is not limited to this. For example, when the information processing apparatus 2 detects the mobile communication terminal 4 of a regular user, the information processing apparatus 2 may also start the Wi-Fi Direct function.

The exemplary embodiment of the present invention is described. However, the present invention is not limited to the above-described exemplary embodiment. Needless to say, a person skilled in the art may devise and embody various modifications.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first wireless communication apparatus that receives data from a mobile communication terminal and that is capable of switching between an active state and a non-active state;
a second wireless communication apparatus that receives first identification information from the mobile communication terminal, wherein a first communication-capable range produced when the first wireless communication apparatus is in the active state overlaps or matches a second communication-capable range of the second wireless communication apparatus; and
an information processing apparatus that generates a switching instruction to switch the first wireless communication apparatus from the non-active state to the active state when the second wireless communication apparatus receives the first identification information.

2. The information processing system according to claim 1,
wherein the information processing apparatus includes
an acquisition unit that acquires the first identification information from the second wireless communication apparatus; and
a generation unit that generates the switching instruction in the case where the first identification information is not identification information registered in advance.

3. The information processing system according to claim 2,
wherein the information processing apparatus further includes
a comparison unit that compares the first identification information obtained from the second wireless communication apparatus with second identification information received from the mobile communication terminal by the first wireless communication apparatus after the first wireless communication apparatus is switched from the non-active state to the active state.

4. The information processing system according to claim 1,
wherein the second wireless communication apparatus restricts transfer of data other than the first identification information in the case where the first identification information is not identification information registered in advance.

5. The information processing system according to claim 1,
wherein the second wireless communication apparatus instructs the information processing apparatus to generate the switching instruction in the case where the first identification information is not identification information registered in advance.

6. The information processing system according to claim 1,
wherein the mobile communication terminal transmits the first identification information and intention information indicating an intention to use the information processing apparatus to the second wireless communication apparatus, and
wherein the information processing apparatus generates the switching instruction when the second wireless communication apparatus receives the first identification information and the intention information.

7. An information processing apparatus in a system which includes a first wireless communication apparatus and a second wireless communication apparatus, the first wireless communication apparatus receiving data from a mobile communication terminal and being capable of switching between an active state and a non-active state, the second wireless communication apparatus receiving identification information from the mobile communication terminal, and in which a first communication-capable range produced when the first wireless communication apparatus is in the active state overlaps or matches a second communication-capable range of the second wireless communication apparatus, the information processing apparatus comprising:
a generation unit that generates a switching instruction to switch the first wireless communication apparatus from the non-active state to the active state when the second wireless communication apparatus receives the identification information.

8. A non-transitory computer readable medium storing a program causing a computer to execute a process executed in a system which includes a first wireless communication apparatus and a second wireless communication apparatus, the first wireless communication apparatus receiving data from a mobile communication terminal and being capable of switching between an active state and a non-active state, the second wireless communication apparatus receiving identification information from the mobile communication terminal, and in which a first communication-capable range produced when the first wireless communication apparatus is in the active state overlaps or matches a second communication-capable range of the second wireless communication apparatus, the process comprising:
generating a switching instruction to switch the first wireless communication apparatus from the non-active state to the active state when the second wireless communication apparatus receives the identification information.
